(19) United States
(12) Patent Application Publication
(10) Pub. No.: US 2007/0000930 A1
(43) Pub. Date: Jan. 4, 2007

(54) Multi-functional child care storage including a warming-in-water compartment

(75) Inventor: Young Jae Kim, Seoul (KR)

Correspondence Address: BACON & THOMAS, PLLC, 625 SLATERS LANE, FOURTH FLOOR, ALEXANDRIA, VA, 22314, US

(73) Assignee: Daewoo Electronics Corporation, Seoul (KR)

(21) Appl. No.: 11/362,754

(22) Filed: Feb. 28, 2006

(30) Foreign Application Priority Data
Jul. 1, 2005 (KR) 10-2005-0059014

(51) Int. Cl. A47J 39/00; A47J 41/00; B65D 71/00; B67D 1/00; A23C 15/04; A45C 11/20; B65D 81/38; B65D 69/00; A23L 1/00; A23C 3/02; B65D 83/72; B65D 88/74

(52) U.S. Cl. 220/592.01; 206/223; 206/541; 99/483; 99/275

(57) ABSTRACT

A multi-functional child care storage includes a warming-in-water compartment for having an infant food or product therein double boiled or kept warm. The warming-in-water compartment includes an outer case inserted in the warming-in-water compartment, having a top opening and a bottom hole respectively formed at a top and a bottom thereof; a heat transferring body exposed to an inside of the outer case through the bottom hole; a heater located beneath the heat transferring body to supply heat thereto; a heater supporter for fixing the heater and the heat transferring body to a lower portion of the outer case in a manner that the heater is interposed between the heater transferring member and the heater supporter; and a thermally conductive inner case, inserted in the outer case and capable of being taken out through the top opening.

### FIELD OF THE INVENTION

The present invention relates to a multi-functional child care storage including a warming-in-water compartment; and, more particularly, to a multi-functional child care storage including a warming-in-water compartment having a heater assembly that is easy to be assembled and can reduce heat transfer from a sheath heater therein to other functional compartments.

### BACKGROUND OF THE INVENTION

In general, a refrigerator is used to keep food or beverage in a refrigerated or frozen state for a long period of time. The refrigerator includes a freezer compartment and a refrigerator compartment. To supply cool air to the freezer compartment and the refrigerator compartment, the refrigerator has a cooling cycle involving a compressor, a condenser, a capillary tube and a cooling device. The compressor compresses a coolant to a high temperature and a high pressure to provide the compressed coolant to the condenser. Then, the condenser converts the compressed coolant into a liquid state of a low temperature and a low pressure by releasing heat of the coolant. The low-temperature low-pressure liquid coolant is then converted into a liquid state of a low temperature and a high pressure while it passes through the capillary tube. The low-temperature high-pressure liquid coolant is then directed to the cooling device installed at a rear side of the freezer compartment. The coolant in the cooling device is converted into a low-pressure state again while it passes through a coolant pipe of the cooling device, and finally evaporates, thereby lowering the temperature of the freezer compartment and the refrigerator compartment.

Recently, with a rise in the standard of living, there have been increasing demands for diversified types of special-purpose refrigerators. Developed to meet such needs and commonly used are, for example, a kimchi refrigerator equipped with an evaporation pipe and a heating wire for the ripening of kimchi, a cosmetic cooler for storing cosmetics, and so forth.

Although such various types of special-purpose refrigerators have been developed, developments have rarely been made upon a storage apparatus for an exclusive use in baby or child care, to which more attention and more investment are given.

If infant food or infant products such as formula, breast milk, medicine and the like are stored in a conventional household refrigerator, they will be soaked with the odors of other foods stored in the refrigerator. As a result, the quality of the infant food or the infant products will be deteriorated and, even worse, hygienic problems may occur. Furthermore, in case of using a microwave to warm up, e.g., formula or breast milk, it is somewhat bothersome to take out formula or breast milk from the refrigerator, and it is difficult to maintain the temperature of formula or breast milk above a specific temperature for a long period of time. Also, purchasing a heating cabinet to warm up or store formula or breast milk warm increases an economic burden, and since the heating cabinet is designed to be used in commercial environments such as hospitals, pharmacies, restaurants, and so forth, it is not suitable for use in home for the purpose of child care.

Moreover, given that a general household sterilizing device is usually designed to be used in sterilizing dishware or utensils used in the kitchen, using it to sterilize infant supplies such as feeding bottles, handkerchiefs, toys and the like is not proper.

Therefore, freed from a conventional conception of electric appliances, it is necessary to develop a new product capable of storing infant products in various ways suitable to their usages, which is easy to assemble and can increase an energy efficiency by minimizing the effect of heat transfer from a high temperature part thereof to a low temperature part thereof.

Further, it is also required to develop a child care storage including a warming-in-water compartment capable of heating with water therein infant foods or products, e.g., breast milk or powdered milk filled in a feeding bottle, as well as keeping them warm in water.

### SUMMARY OF THE INVENTION

It is, therefore, an object of the present invention to provide a multi-functional child care storage including a warming-in-water compartment capable of heating with water therein infant foods or products as well as keeping them warm in water.

In accordance with one aspect of the present invention, there is provided a multi-functional child care storage comprising a plurality of functional compartments, the plurality of the functional compartments including a warming-in-water compartment for having an infant food or product therein double boiled or kept warm, wherein the warming-in-water compartment includes: an outer case inserted in the warming-in-water compartment, having a top opening and a bottom hole respectively formed at a top and a bottom thereof; a heat transferring body made of a thermally conductive material, whose upper portion is exposed to an inside of the outer case through the bottom hole; a heater for generating heat, located beneath the heat transferring body to supply the generated heat thereto; a heater supporter for fixing the heater and the heat transferring body to a bottom area of the outer case in a manner that the heater is interposed between the heater transferring member and the heater supporter; and an inner case, made of a thermally conductive material, inserted in the outer case to be mounted on the upper portion of the heat transferring body in a manner capable of being taken out through the top opening.

In accordance with another aspect of the present invention, there is provided a heater assembly for use in a warming-in-water compartment of a multi-functional child care storage, including: an outer case inserted in the warming-in-water compartment, having a top opening and a bottom hole respectively formed at a top and a bottom thereof; a heat transferring body made of a thermally conductive material, whose upper portion is exposed to an inside of the outer case through the bottom hole; a heater for generating heat, located beneath the heat transferring body to supply the generated heat thereto; a heater supporter for fixing the heater and the heat transferring body to a bottom area of the outer case in a manner that the heater is interposed between the heater transferring member and the heater supporter.

### BRIEF DESCRIPTION OF THE DRAWINGS

The above and other objects and features of the present invention will become apparent from the following description of preferred embodiments given in conjunction with the accompanying drawings, in which:

FIG. 1 shows a perspective view of a multi-functional child care storage including a warming-in-water compartment in accordance with the present invention, wherein all doors thereof are opened;

FIG. 2 is a front cross sectional view of the multi-functional child care storage in accordance with the present invention;

FIG. 3 sets forth a front cross sectional view of the warming-in-water compartment in accordance with the present invention; and

FIG. 4 depicts an exploded perspective view of the heater assembly in accordance with the present invention.

### DETAILED DESCRIPTION OF THE PREFERRED EMBODIMENTS

Hereinafter, preferred embodiments of the present invention will be described with reference to the accompanying drawings in such detail that they can be readily implemented by those skilled in the art.

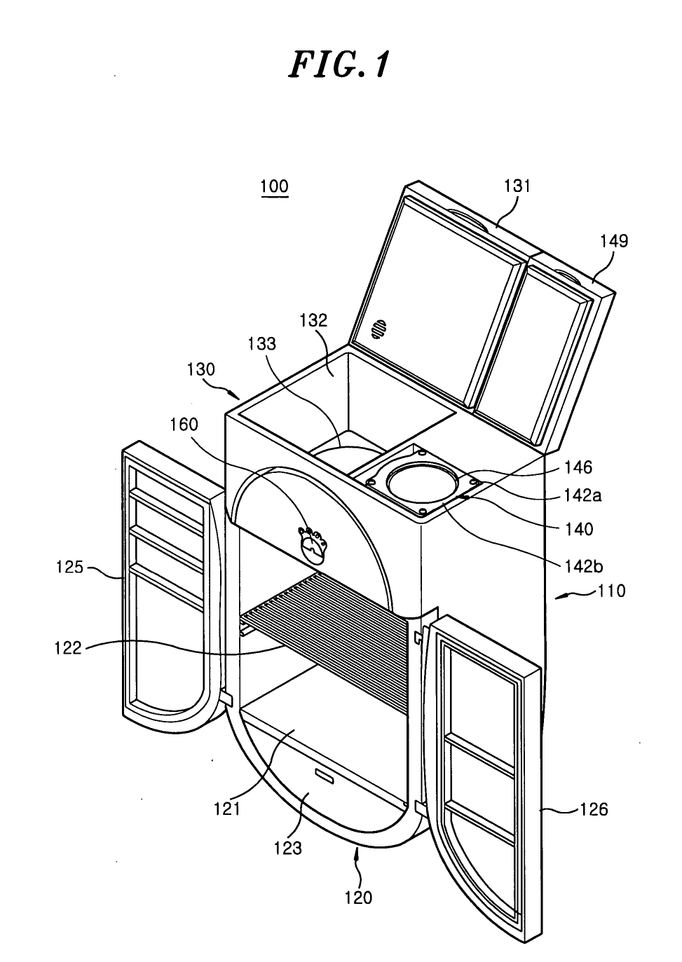

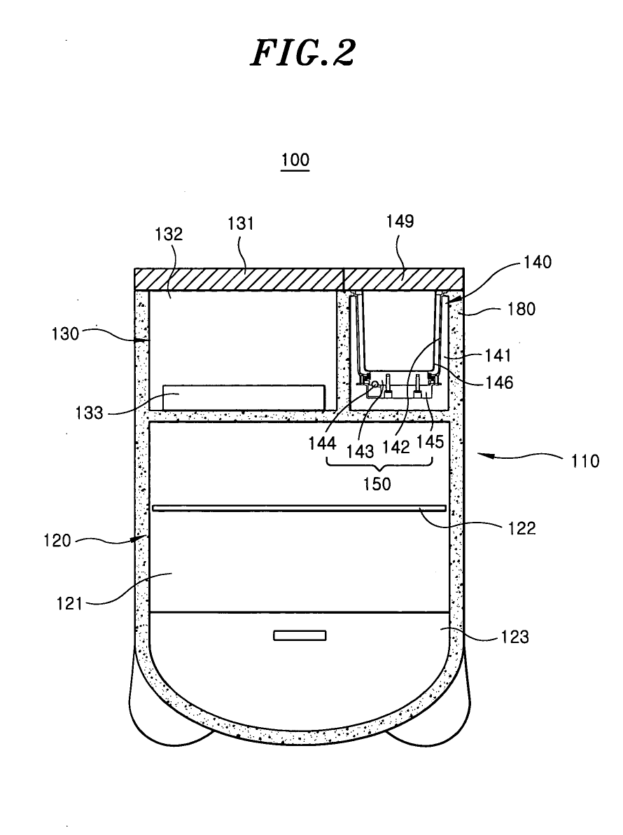

FIG. 1 shows a perspective view of a multi-functional child care storage in accordance with the present invention. Further, FIG. 2 is a front cross sectional view of the multi-functional child care storage in accordance with the present invention.

As shown therein, the multi-functional child care storage 100 in accordance with the present invention is provided with a plurality of functional compartments in a main body 110 thereof. The plurality of functional compartments include a refrigerating compartment 120; a sterilizing compartment 130; and a warming-in-water compartment 140.

The refrigerating compartment 120 is opened and closed by doors 125 and 126 hinge-connected to edges of the main body 110 to define a refrigerating space 121. In the refrigerating space 121, a shelf 122 and a storage drawer 123 are installed to load or store infant foods or products, and infant foods or products loaded on the shelf 122 or stored in the drawer 123 are refrigerated by a thermoelectric element (not shown) or a cooling device (not shown).

The sterilizing compartment 130, provided at an upper portion of the main body 110, is opened and closed from above by a door 131 to define a sterilizing space 132 partitioned in the main body 110. In the sterilizing space 132, a stack mount 133 is installed, on which the infant products are placed. And the infant products placed on the stack mount 133 are sterilized by steam generated by a heater or ultraviolet rays of an ultraviolet ray sterilizing lamp.

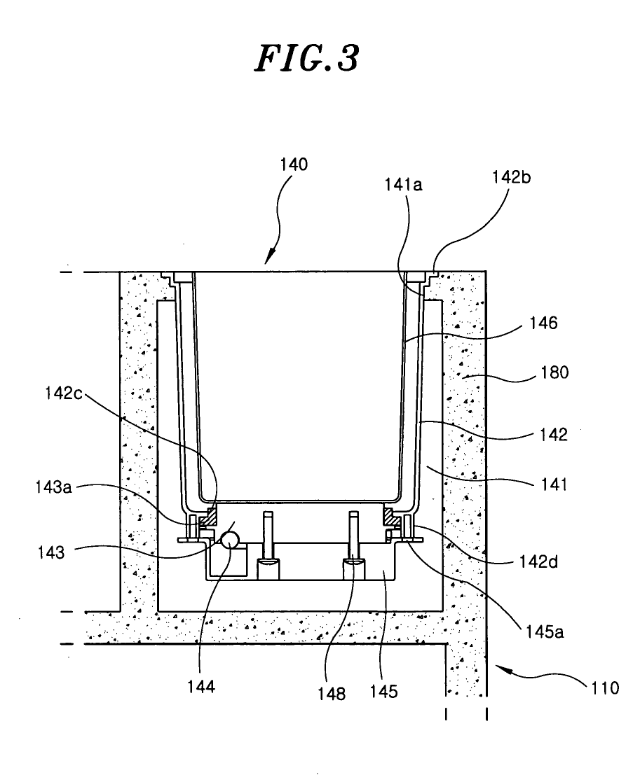

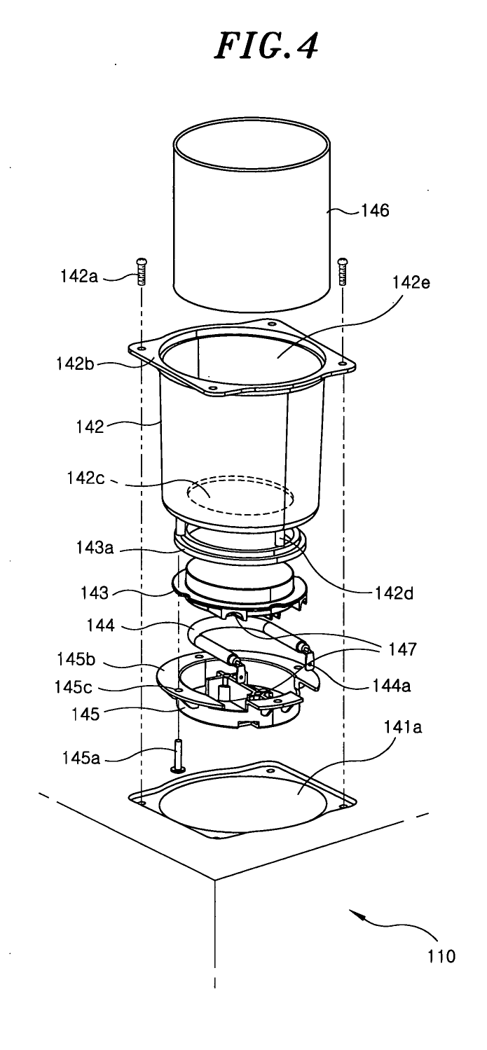

The warming-in-water compartment 140 is provided at an upper portion of the main body 110, such that it is located adjacent to the sterilizing compartment 130. The warming-in-water compartment 140, whose outer opening 141a formed at an upper surface thereof is opened and closed by a door 149 to define an installation space 141, and includes a heater assembly 150 having a heater 144 for generating heat and an inner case 146. Herein, the heater 144 in the assembly 150 is positioned to be distanced by at least a predetermined distance from other functional compartment, e.g., the refrigerating compartment 120, whose inside is at a temperature lower than that of the warming-in-water compartment. Details of the warming-in-water compartment 140 will be described with reference to FIGS. 3 and 4 as follows.

FIG. 3 sets firth a front cross sectional view of the warming-in-water compartment 140 shown in FIG. 2; and FIG. 4 depicts an exploded perspective view of the heater assembly shown in FIG. 3.

The heater assembly 150 includes an outer case 142 inserted in the warming-in-water compartment 140, having a top opening 142e and a bottom hole 142c respectively formed at a top and a bottom thereof; a heat transferring body 143 made of a thermally conductive material, whose upper portion is exposed to an inside of the outer case 142 through the bottom hole; the heater 144 for generating heat, located beneath the heat transferring body 143 to supply the generated heat thereto; a heater supporter 145 for fixing the heater 144 and the heat transferring body 143 to a bottom area of the outer case 142 in a manner that the heater 144 is interposed between the heater transferring member 143 and the heater supporter 145.

Further, the inner case 146, made of a thermally conductive material, is inserted in the outer case 142 to be mounted on the upper portion of the heat transferring body 143 in a manner capable of being taken out through the top opening 142e.

A fixing portion 142b is horizontally protruded from a top periphery of the outer case 142 to encircle the top opening 142e, and is fixed to and supported by an outer peripheral area around the outer opening 141a by means of a plurality of first fixing members 142a (only two of them are shown in FIG. 4) such as bolts or screws. Herein, the outer case 142 is positioned in the warming-in-water compartment 140 in a manner to allow the heater 144 to be distanced by at least the predetermined distance from other functional compartment whose inside is at a temperature lower than that of the warming-in-water compartment, e.g., the refrigerating compartment 120.

The heat transferring body 143 is located beneath the outer case 142. An upper surface of the heat transferring body 143 is flat, and exposed to an inside of the outer case 142 through the bottom hole 142c. Between the heat transferring body 143 and the bottom hole 142c is inserted a sealing member 143a for sealing a gap therebetween. Further, the heater 144 is located beneath the heat transferring body 143.

The heater 144 is preferably a sheath heater including a C-shaped pipe in which one or more heating coils are embedded and a pair of terminals 144a for supplying an electric power thereto, and can be made in a variety of shapes to enhance the energy efficiency and facilitate its installation. In general, sheath heaters have a good durability with respect to, e.g., vibration. The heater 144, fixed between the heat transferring body 143 and the heater supporter 145, makes contact with the heat transferring body 143 to supply heat thereto, thereby allowing heat radiated from the bottom hole 142c to the inside of the outer case 142.

The heater 144 is operated by manipulating an operation panel 160 provided in a front surface of the main body 110. The operating panel 160 may include a power switch for turning on and off the heater 144; a timer for setting a specific period of time for which the heater 144 is kept activated; and a temperature control switch for controlling a temperature of the heater 144. A control unit (not shown) receives a temperature signal from a temperature sensor (not shown) installed around the heater 144, and controls the heater 144 in response to a user's commands inputted by using the operation panel 160. More specifically, the control unit controls the heater 144 to be turned on/off, to maintain a specific temperature range, to keep activated only for a specific period of time, and so forth.

The heater supporter 145 is coupled to a bottom of the outer case 142 as follows. A coupling portion 145b, horizontally protruded from a top periphery of the heater supporter 145, has a plurality of through holes 145b formed thereon. Further, a plurality of fixing protrusions 142d are downwardly protruded from the bottom area of the outer case 142, and each of the fixing protrusions 142d has a screw hole formed therein. Thus, the fixing protrusions 142d are inserted into the through holes 145b, and fixed thereto by means of a plurality of second fixing members 145a (only one of them is shown in FIG. 4) such as bolts, screws or the like fixedly inserted in the screw holes of the fixing protrusions 142d. In this manner, the heater 144 and the heat transferring body 143 are fixed to the outer case 142, wherein the heater 144 is positioned to be distanced by at least the predetermined distance from other functional compartment whose inside is at a temperature lower than that of the warming-in-water compartment, e.g., the refrigerating compartment 120.

Further, a recess portion 147 is formed on a bottom of the heat transferring body 143 for interposing the heater 144 between the recess portion 147 and an upper portion of the heater supporter 145. Further, the heat transferring body 143 may be coupled with the heater supporter 145 by means of a plurality of third fixing members (not shown) such as bolts, screws or the like.

The inner case 146 is removably inserted in the outer case 142 to be mounted on the upper portion of the heat transferring body 143. Thus, the inner case 146 is supplied with heat generated by the heater 144 via the heat transferring body 143, so that water contained therein can be heated to thereby heat infant foods or products immersed in the water. In this manner, the infant foods or products can be double boiled or kept at a warm temperature.

Meanwhile, heat transfer between the functional compartments 120, 130 and 140 is obstructed by an insulating member 180. The child care storage in accordance with the present invention may additionally be provided with, e.g., a heating compartment for keeping infant foods or products warm by means of a heater or a thermoelectric element therein, a freezing compartment for freezing infant foods or products through a heat exchange with coolant, or a heating/refrigerating compartment for selectively keeping infant products warm or refrigerated.

Hereinafter, an operation of the multi-functional child care storage with the above-described configuration will be explained.

Firstly, the inner case 146 is inserted into the outer case 142 to be mounted on the upper surface of the heat transferring body 143 exposed to the inside of the outer case 142. Then, water is poured into the inner case 146, and infant foods or products to be double boiled or kept at a warm temperature are put into the water. Thereafter, the heater 144 is activated by a control of the operation panel 160, so that heat generated by the heater 144 is transferred to the inner case 146 via the heat transferring body 143 to have the infant foods or products in the inner case 146 double boiled or kept at a warm temperature.

At this time, by receiving a temperature detection signal transmitted from the temperature sensors (not shown) installed around the heater 144, the control unit (not shown) controls the heater 144 to maintain at a preset temperature, for example, 35˜40° C. or preferably about 37° C., in case of warming formula. The preset temperature can be set by manipulating the temperature control switch provided on the operation panel 160. Further, an operation time of the heater 144 can also be set by the timer provided on the operation panel 160, wherein the operation time is a specific period of time for which the heater 144 is kept activated.

As described above, the multi-functional child care storage 100, including a plurality of the functional compartments 120, 130 capable of storing infant products in various ways suitable to their usage, further includes the warming-in-water compartment 140 for heating or maintaining a temperature of infant foods or products. Thus, the living space can be used more efficiently, and the time and effort for child chare can be saved.

Further, the heater assembly 150 can be easily assembled and installed. In addition, heat transfer to the other low-temperature functional compartments 120, 130 can be minimized because the heater assembly 150 is distanced by at least the predetermined distance from other functional compartment of low temperature, e.g., the refrigerating compartment, thereby improving the energy efficiency.

While the invention has been shown and described with respect to the preferred embodiments, it will be understood by those skilled in the art that various changes and modifications may be made without departing from the scope of the invention as defined in the following claims.

What is claimed is:

1. A multi-functional child care storage comprising a warming-in-water compartment for having an infant food or product therein heated or kept warm in water,
wherein the warming-in-water compartment includes:
an outer case inserted in the warming-in-water compartment, having a top opening and a bottom hole respectively formed at a top and a bottom thereof;
a heat transferring body made of a thermally conductive material, whose upper portion is exposed to an inside of the outer case through the bottom hole;
a heater for generating heat, located beneath the heat transferring body to supply the generated heat thereto;
a heater supporter for fixing the heater and the heat transferring body to a bottom area of the outer case in a manner that the heater is interposed between the heater transferring member and the heater supporter; and
an inner case, made of a thermally conductive material, inserted in the outer case to be mounted on the upper portion of the heat transferring body in a manner capable of being taken out through the top opening.

2. The multi-functional child care storage of claim 1, wherein the outer case further has:
a fixing portion horizontally protruded from a top periphery of the outer case to encircle the top opening, fixed to and supported by an outer peripheral area of an upper surface of the warming-in-water compartment by means of a plurality of first fixing members.

3. The multi-functional child care storage of claim 2, wherein the heating transferring body has:
a recess portion formed on a bottom of the heating transferring body for interposing the heater between the recess portion and an upper portion of the heater supporter.

4. The multi-functional child care storage of claim 3, wherein the heater supporter has:
a coupling portion horizontally protruded from a top periphery of the heater supporter, and
wherein the coupling portion is fixed to the bottom area of the outer case.

5. The multi-functional child care storage of claim 4, wherein the coupling portion has a plurality of through holes formed thereon, and the outer case further has:
a plurality of fixing protrusions downwardly protruded from the bottom area of the outer case, and
wherein the fixing protrusions are inserted into the through holes, and fixed thereto by means of a plurality of second fixing members.

6. The multi-functional child care storage of claim 1, wherein the heater has:
a pipe in which one or more heating coils are embedded; and
a pair of terminals for supplying an electric power to the heating coils.

7. A heater assembly for use in a warming-in-water compartment of a multi-functional child care storage, comprising:
an outer case inserted in the warming-in-water compartment, having a top opening and a bottom hole respectively formed at a top and a bottom thereof;
a heat transferring body made of a thermally conductive material, whose upper portion is exposed to an inside of the outer case through the bottom hole;
a heater for generating heat, located beneath the heat transferring body to supply the generated heat thereto;
a heater supporter for fixing the heater and the heat transferring body to a bottom area of the outer case in a manner that the heater is interposed between the heater transferring member and the heater supporter.

8. The heater assembly of claim 7, wherein the outer case further has:
a fixing portion horizontally protruded from a top periphery of the outer case to encircle the top opening, fixed to and supported by an outer peripheral area around an opening of the heat boiling compartment by means of a plurality of first fixing members.

9. The heater assembly of claim 8, wherein the heating transferring body has:
a recess portion formed on a bottom of the heating transferring body for interposing the heater between the recess portion and an upper portion of the heater supporter.

10. The heater assembly of claim 9, wherein the heater supporter has:
a coupling portion horizontally protruded from a top periphery of the heater supporter, and
wherein the coupling portion is fixed to the bottom area of the outer case.

11. The heater assembly of claim 10, wherein the coupling portion has a plurality of through holes formed thereon, and the outer case further has:
a plurality of fixing protrusions downwardly protruded from the bottom area of the outer case, and
wherein the fixing protrusions are inserted into the through holes, and fixed thereto by means of a plurality of second fixing members.

12. The heater assembly of claim 11, wherein the heater has:
a pipe in which one or more heating coils are embedded; and
a pair of terminals for supplying an electric power to the heating coils.
